(19) United States
(12) Patent Application Publication
(10) Pub. No.: US 2026/0065280 A1
(43) Pub. Date: Mar. 5, 2026

(54) MACHINE LEARNING SYSTEM FOR AUTOMATED SUBJECTIVE DECISION MANAGEMENT

(71) Applicant: AMERICAN EXPRESS TRAVEL RELATED SERVICES COMPANY, INC., New York, NY (US)

(72) Inventors: Shailendra GUPTA, Haryana (IN); Ashi Kalra SAWHNEY, Haryana (IN); Anshul JAIN, Haryana (IN); Vishal MALHOTRA, Haryana (IN); Megha GROVER, New Delhi (IN); Varun SAXENA, Madhya Pradesh (IN); Ravi BAJPAI, Haryana (IN); Manupriya AGARWAL, Uttar Pradesh (IN); Kartikay CHADHA, Haryana (IN)

(73) Assignee: AMERICAN EXPRESS TRAVEL RELATED SERVICES COMPANY, INC., New York, NY (US)

(21) Appl. No.: 18/819,914

(22) Filed: Aug. 29, 2024

(51) Int. Cl. G06Q 20/40

(52) U.S. Cl. CPC G06Q 20/4016

(57) ABSTRACT

Disclosed herein are system, method, and computer program product embodiments for a transaction management system. The transaction management system may receive a request, e.g., transaction data, from a merchant system. The transaction management system may also receive metadata associated with a corresponding transaction card holder. The transaction management system may analyze the transaction using a system employing machine learning model(s) to perform functions such as pattern recognition and anomaly detection. Transaction management system may also use machine learning systems to manage approval and payment for transactions, especially in the context of new and unforeseen transactions. Transactions may be classified so that the transaction may be automatically approved, in need of additional review, or denied. Each of these classifications may be decided without input or oversight from users.

### BACKGROUND

### Field

This field is generally related to machine learning system for automated subjective decision making.

### Related Art

Evaluating transactions as being allowed or prohibited transactions is a time consuming task because of the number of transactions for a particular organization. It is typically a manually intensive process requiring submissions from the user performing the transactions (i.e., having to manually submit approval requests) and internal review of the submissions against organizational policy (i.e., whether the transactions fall into pre-approved categories). Accordingly, currently existing systems that determine whether transactions are allowed often require manual input and manual classification of the transaction type, i.e., relying on subjective decisions via a manual review. Currently existing systems lack the intelligence to automate subjective decisions when those decisions need to extend beyond pre-approved requirements and categories.

### BRIEF SUMMARY

Disclosed herein are system, apparatus, device, method and/or computer program product embodiments, and/or combinations and sub-combinations thereof, for a machine learning system for improved subjective decision making using a pattern recognition system that is trained to detect anomalous patterns and to manage approval and payment for transactions, especially in the context of new and unforeseen transactions. The pattern recognition system may be implemented in a system that processes thousands of transactions from thousands of users who utilize transaction cards of an organization, e.g., corporate transaction cards. In some embodiments, the systems and methods described herein may be used to provide a framework for a machine learning system for improved subjective decision management system. The framework may provide detailed analysis of the transaction data and metadata of the transaction card account holder. This analysis may provide decision management on whether the plurality of trained pattern recognition subsystems indicate the transaction should be approved, denied, or in need of additional review. Based on the decision management, an approved transaction may be reimbursed to the transaction card from the organization's account and denied transactions may not be reimbursed. Neither of these decisions may require any manual input or oversight. The decision management system may also identify a transaction as needing additional oversight before approving or denying the transaction, according to organizational policies.

### BRIEF DESCRIPTION OF THE DRAWINGS

The accompanying drawings are incorporated herein and form a part of the specification.

FIG. 1 depicts a block diagram of a machine learning system integration environment, according to some embodiments.

FIG. 2 depicts a flowchart illustrating a method for analyzing and approving transaction data by transaction management system, according to some embodiments.

FIG. 3A depicts a flowchart illustrating a method for determining a transaction data does not comply with a reimbursement policy, according to some embodiments.

FIG. 3B depicts a flowchart illustrating a method for performing a transaction reimbursement approval action, according to some embodiments.

FIG. 4 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Currently existing automated services lack the ability to make subjective decisions because they do not analyze the transactions beyond approved categories. They are unable to accurately approve or decline transactions that do not fit within the pre-approved categories. This may lead to an automated system that provides a rubber stamp of approval as long as the manually entered transaction meets these requirements and/or denial of transactions that should be approved but were inputted incorrectly or do not meet a strict set of pre-approved categories.

Such currently existing systems can cause significant inaccuracies in transaction approval and denial. The transaction management system disclosed herein uses machine learning models to automate subjective decision making when classifying the transaction requests, and in some embodiments, when those transaction requests fall outside of pre-approved categories. Requests may be routed to various subsystems employing different recognition and detection functions to characterize transactions. This allows the system to accurately classify transaction data that falls into categories that may be new or unknown. The system may use previous behavior within the organization, previous user behavior, and/or organizational policies to continuously train machine learning systems to perform pattern recognition, anomaly detection, and subjective decision making. Therefore, the current system is able to anticipate fraudulent transactions, which enables it to have autonomy in approving, denying, and requesting additional review of requests.

Currently existing systems previously routed receipts and reimbursement requests for approval to a user computer system for manual review and approval. In some instances, currently existing systems may have limited automation. For example, a manually produced request may have been routed to a system that provided approval if the request checked certain boxes in the pre-approved categories. These systems are limited to binary determinations in pre-approved, known categories. The current system may implement additional components for, first, retrieving requests (e.g., transaction data) without manual input, and second, classifying requests differently based on the analysis from various subsystems. Examples of these classifications may include requests that can be automatically approved, requests that require additional review (e.g., manual expensing), and requests that can be automatically rejected. Requests and their respective classification may be stored to train and re-train the machine learning models of the machine learning systems used to anticipate fraudulent behavior that should result in a request being denied or reviewed.

Provided herein are system, apparatus, device, method and/or computer program product embodiments, and/or combinations and sub-combinations thereof, machine learning system for automated subjective decision making using pattern recognition system that is trained to detect anomalous patterns and to manage approval and payment for transactions, especially in the context of new and unforeseen transactions.

In some embodiments, the systems and methods described herein provide a framework for an improved transactions management system for streamlining the process of approving or declining transactions. Improvements include removing the need for a user to manually submit a request for approving the transaction and providing automated subjective decision making through machine learning systems.

The machine learning systems may be implemented as one or more machine learning model trained with previous user and organizational behavior to anticipate fraudulent transactions. Conventional transaction management systems are limited to being initiated upon user requests for approving or denying a transaction and also limited to making these decisions according to pre-approved categories based on information in the user request. In contrast, the system of the present disclosure provides automated subjective decisioning, or decision making, without having to wait for a user request. The transaction management system may facilitate direct communications between a transaction system (e.g., a merchant server) and the improved transaction management system. Requests (e.g., transaction data) may be routed directly to transaction management system, without the need for manual action to initiate the approval process (e.g., a client reimbursement request). Transaction data may be routed to one or more machine learning systems trained to perform analysis including pattern recognition, anomaly detection, behavior predictions, and similar analysis. The machine learning systems may determine whether there are failure states for the performed analysis. A failure state may be different for each of the analysis, (e.g., transaction data that indicates an anomaly, predictive behavior that indicates future non-payment, failure to adhere to organizational policies for business travel). Failure state information may be provided to the transaction management system from the one or more machine learning subsystems. The information may be used to decide whether the transaction should be approved and reimbursed, denied, or routed for additional review. In some embodiments, the transaction management system may be integrated within a corporate enterprise network for automating the expense approval process within the network. These machine learning systems eliminate pre-approved categories, replacing it with a set of dynamic rules to allow the transaction management system to subjectively classify transactions.

The framework may provide detailed analysis of the transaction data and metadata of the transaction card holder to provide insight on whether the transaction should be approved. Transactions that are approved may be automatically approved and the transaction may be reimbursed. The transaction management system may generate a request to reimburse approved transactions. The approved reimbursement request may be transmitted to a financial institution of the organization. In some embodiments, funds may be transferred directly to the transaction card, allowing the entire approval decision process to take place without manual input or intervention. The financial account may be an account with the issuing financial institution of the transaction card and/or a financial institution other than the issuing financial institution of the transaction card.

In some embodiments, the transaction management system may use a transaction data evaluation engine and transaction approval layer to determine whether any failure states exist and if the transaction should be approved, denied, or requested for additional review. Transaction data and metadata of the transaction card may be analyzed in different categories with one or more thresholds that indicate a failure state. The categories may include personal spend, anomaly detection, policy non-compliance, pattern recognition, payment risk, and/or questionable spend. Additional or fewer categories may be included depending of the reimbursement policies of the organization. The policies may also determine the thresholds of the categories, e.g., maximum personal spend on transportation, lodging, and/or other travel and entertainment spending.

In some embodiments, the transaction management system may determine that the transaction data is moderate (e.g., needing additional review) or critical (e.g., denied). Moderate transactions may fall meet the thresholds, but near the limits. The transaction may still be approved, but may require review of the data analyzed by the transaction management system before reimbursement. Organizational policy may indicate that some failure states are allowable and deemed moderate. Depending on the policy, no failure states may exist, one or more failure states may exist, and/or only failure states in certain categories. If the transaction management system determines that a transaction is critical, the transaction may not be approved or reimbursed.

In some embodiments, transaction management system may transmit a message comprising the analysis to a client decision system. The message may include data to be visually displayed on a graphical user interface (GUI) at the client decision system. The message may provide details on the analysis of the threshold in each of the categories, the determined healthy, moderate, or critical classification, and/or approval and reimbursement status of the transaction associated with the transaction card and transaction card holder.

In some embodiments, the transaction management system may use the transaction approval layer to analyze the failure states, if any, transmitted from the transaction data evaluation engine. Transaction approval layer may use one or more machine learning models trained using information from the reimbursement policy of the organization, transaction data of the current transaction, and previous transaction data of the transaction card holder and other transaction card holders in the organization to determine if the transaction is healthy, moderate, or critical. In some embodiments the machine learning model may be re-trained as additional data is stored in customer metadata database and transaction data database. In some embodiments, transaction management system may receive a determination from the client transaction system determining a final classification for a moderate transaction. Transaction management system may use this determination to re-train the machine learning models used for the transaction data evaluation engine and the transaction approval layer.

Various embodiments of these features will now be discussed with respect to the corresponding figures.

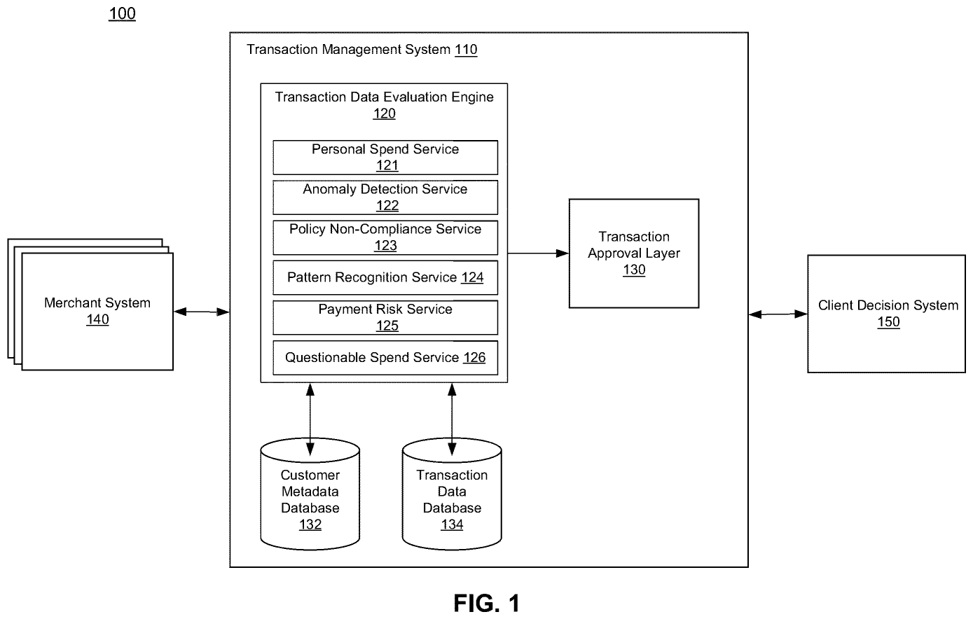

FIG. 1 depicts a block diagram of transaction management system environment 100 for automatic approval and reimbursement of transactions, according to some embodiments. Transaction management system environment 100 may include transaction management system 110, merchant system 140, and client decision system 150. In some embodiments transaction management system 110 may include, transaction data evaluation engine 120, transaction approval layer 130, customer metadata database 132, and/or transaction data database 134. Transaction data evaluation engine 120 may further include personal spend service 121, anomaly detection service 122, policy non-compliance service 123, pattern recognition service 124, payment risk service 125, and/or questionable spend service 126. Transaction management system 110 may analyze transaction data associated with a transaction card. Transaction data may be received from merchant system 140. Transaction data evaluation engine 120 may analyze the transaction data and/or metadata using services 121-126. Additional information may be used for analysis from customer metadata database 132 and/or transaction data database 134. Transaction approval layer 130 may determine whether the transaction data and/or metadata satisfy the threshold of services 121-126 and if there are any failure states. Transaction management system 110 may transmit a message to client management system 150 including the analysis of the transaction data by transaction management system 110, approval status, and/or reimbursement status for the transaction on the transaction card.

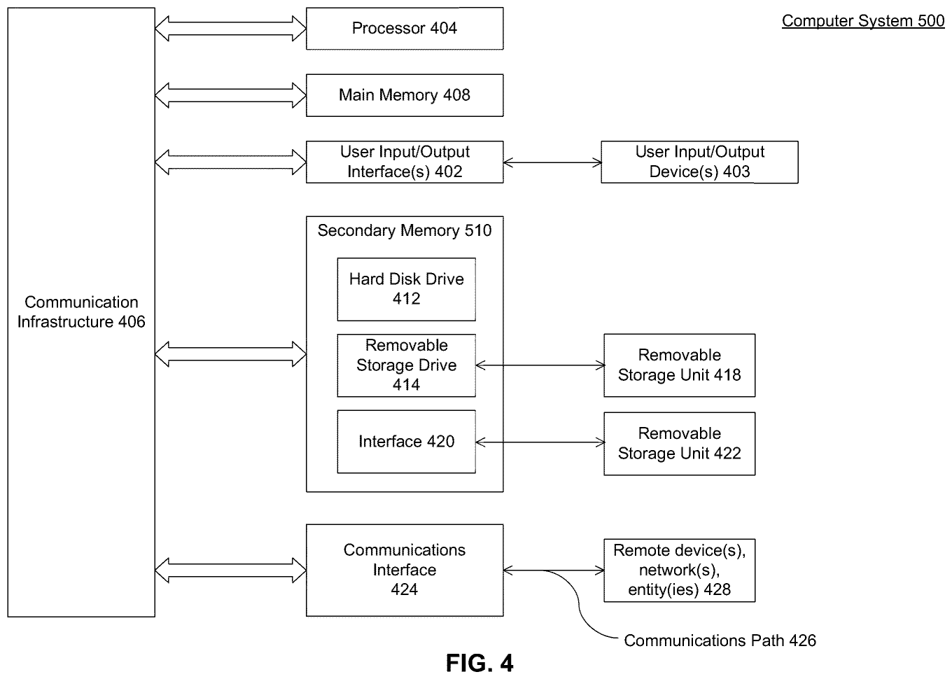

Transaction management system 110 may be implemented using one or more servers, services, databases, and/or a combination thereof. For example, transaction management system 110 may be implemented using one or more enterprise servers, databases, and/or computer system 500 as described with reference to FIG. 4 to perform the transaction management described herein.

Transaction management system 110 may analyze transaction data and metadata to determine whether transactions on a transaction card should be approved and reimbursed. The transactions may be from a transaction card holder at one or more merchant systems, e.g., a point-of-sale device of a merchant. Transaction management system 110 may collect metadata related to the transaction, transaction card holder, and/or merchant. Metadata may include category of goods and/or services of the transaction, type of merchant, transaction history of the transaction card holder, and/or additional transaction related data. This information may be used by transaction data evaluation engine 120 to determine whether the transaction should be approved. Metadata and/or transaction data may be stored using customer metadata database 132 and/or transaction data database 134. Transaction data evaluation engine 120 may use the data stored in the databases in analyzing the transactions. In some embodiments, transaction management system 110 may receive additional business travel information from client decision system 150, e.g., trip itineraries from for employees confirming they will be on business travel. Business travel information may also be determined for a transaction based on the holistic analysis of a transaction. For example, a transaction may include transaction data for transportation, lodging, and/or food and beverage purchases. Individually, the transaction data may not be sure enough to indicate business travel. However, when viewed together, with timing and location information, transaction management system 110 may determine there is business travel. Transaction management system 110 may use transaction data for all of the transactions within the relevant time frame to help analyze the individual transactions. For example, transaction data may indicate a flight and hotel books for the same days. Both of these transactions may provide relevant context for the nature of the individual transaction.

In some embodiments, transaction data evaluation engine 120 may identify whether the transaction data is applicable to services 121-126. Transaction data evaluation engine 120 may apply transaction data and/or metadata to the services 121-126 to determine if the transaction data and/or metadata satisfy the thresholds of the respective service. For example, transaction data may include air travel for work-related travel. The transaction for air travel may be analyzed by each service 121-126. Personal spend service 121 may analyze the transaction data to determine if the transaction falls within travel and entertainment transactions typical for businesses. If the transaction data falls within the category of travel and entertainment, anomaly detection service 122 may analyze the transaction data against known anomalies. Policy non-compliance service 123 may analyze transactions against the policy of the organization. Pattern recognition service 124 may detect patterns that may indicate a transaction card holder is colluding with a merchant through purchases that will be reimbursed. Payment risk service 125 may predict the next stage of delinquency for a transaction card holder and assess credit loss risk due to non-repayment. Questionable spend service 126 may determine whether the transaction data falls within risky categories, e.g., uncommon categories for organizational spending. Transaction approval layer 130 combines the information from each service 121-126 and determines if there are any failure states. For example, if the transaction data and/or metadata does not meet the threshold or falls outside of a reimbursable transaction according to the policies implemented through services 121-126, transaction approval layer 130 may determine there is a failure state for the corresponding service.

As described herein, transaction management system 110 may be customizable to the organization. Transaction data evaluation engine 120 and services 121-126 may be customized to apply the specific policies of the organization authorizing the transaction card to the transaction card holder. In some embodiments, transaction data evaluation engine 120 may implement corporate reimbursement policies. For example, if there is a policy that only transportation transactions less than $500 will be reimbursed, services 121-126 may apply this threshold to the transaction data. In another example, there may be a preferred merchants in certain transaction categories, when available. Services 121-126 may use a combination of transaction data and metadata to determine whether the transaction card holder had the merchant available and whether they used the preferred merchant. In some embodiments, service 121-126 may be implemented using machine learning techniques. This may allow services 121-126 to perform improved subjective decisioning regarding whether transaction data cause a failure state. In some embodiments, transaction data may initially be classified as moderate or critical, but later approved by client decision system 150. Services 121-126 may update the respective machine learning models to identify a new threshold for the corresponding service. This may allow services 121-126 to predict unforeseen fraudulent transactions.

In some embodiments, a policy or portion of the policy may be applied to multiple services. Using the previous example, a policy identifying a preferred merchant may be used by personal spend service 121, anomaly detection service 122, policy non-compliance service 123, and/or pattern recognition service 124. Applying the policy to multiple services creates a redundancy that may increase the accuracy of classifying transactions as healthy, moderate, or critical. This in return allows the system to fully automate the transaction approval and reimbursement process without, or with significantly less, manual intervention from a transaction auditing team. This provides an advantage over current technology that requires users to submit expenses and manually review the expenses for approval before reimbursement. In some embodiments, the organization may not have a detailed policy on reimbursements. Transaction management system 110 may use trends in spending to determine spend threshold for various transactions. Transactions outside of the standard deviation may cause a failure state and depending on the standard deviation, the expense may be classified as moderate or critical. An advantage of transaction management system 110 being implemented by an issuing financial institution is the ability to gather and use data to determine spending threshold based on a wide range of available customer data. In some embodiments, the machine learning systems using machine learning models to perform decisioning, e.g., services 121-126 and transaction approval layer 130, may be re-trained with this data to continuously anticipate fraudulent and approved spending behaviors.

As described above, personal spend service 121 may determine whether transaction data and/or metadata indicates whether the transaction is a reimbursable transaction. Personal spend service 121 may determine, based on the transaction data and/or merchant metadata, a travel and entertainment transaction from a non-travel and entertainment transaction. For example, travel and entertainment transactions may be transportation, lodging, and/or food and beverage. In some embodiments, the policy of the organization may further define or broaden transactions considered travel and entertainment. As the machine learning model is trained based on the information in the policy and continuously re-trained using transaction data of transaction card holders, personal spend service 121 may be able to subjectively determine failure states related to business versus personal transactions.

For travel and entertainment transactions, personal spend service 121 may compare the transaction data and/or metadata in four areas to determine whether the transaction further falls within business travel and entertainment. Personal spend service 121 may compare the transaction data of the current transaction to the transaction data history stored in transaction data database 134. The transaction data history may include transactions by the transaction card holder and/or colleagues of the transaction card holder using transaction cards authorized by the organization. Personal spend service 121 may also receive information from the organization indicating whether the transaction card holder was on business travel at the time of the transaction. In some embodiments, personal spend service 121 may access the customer metadata database 132 to compare the transaction data of the current transaction to previously approved transactions for the transaction card holder.

For example, a transaction card holder, e.g., an employee of an organization, may book an air ticket from Washington, D.C. to New York City using their transaction card. Personal spend service 121 may access databases 132 and 134 to determine the transaction card holder has a history of travel to New York City, a successful transaction reimbursement history, and/or similar travel history from colleagues. Personal spend service 121 may determine the transaction is business travel and transmit information to transaction approval layer 130 indicating the business travel thresholds are satisfied and there is no failure state.

Based on these comparisons, personal spend service 121 may determine that the transaction data and/or metadata indicates the transaction is related to business travel and entertainment. In some embodiments, there may not be data to accurately make a comparison. For example, for the first transaction by a transaction card holder there may not be a transaction history or approved transaction reimbursement history for the transaction card holder. However, personal spend service 121 may still compare the transaction data with colleague transaction data and or business travel information from the organization. If any of the comparisons indicate the transaction is not a related to business travel and entertainment, personal spend service 121 may signal a failure state to transaction approval layer 130. In another example, a transaction card holder may book air travel from New York City to the Maldives. Personal spend service 121 may recognize the Maldives as a frequent leisure location. If there is no travel history to this location from the transaction card holder or colleagues and no organizational information to indicate business travel, personal spend service 121 may determine the transaction data is not business travel. In response, personal spend service 121 may transmit to transaction approval layer 130 the failure state.

In some embodiments, if the transaction is related to travel and entertainment, but not a business travel, personal spend service 121 may transmit to transaction approval layer 130 the failure state. If appropriate, when considering the information from services 122-126 as well, transaction approval layer 130 may determine the transaction is moderate. Depending on the policy of the organization, the moderate transaction may be approved, or preliminarily approved, and sent to client decision system 150 for final approval.

In some embodiments, transactions deemed non-travel and entertainment may be further analyzed to determine whether they are in risk categories or non-traditional business travel transactions. Personal spend service 121 determines the category of the transaction, whether the category is considered risky or not. For example, risky categories of transaction may include jewelry, leisure activities, clubs, adult entertainment services, and/or other categories that indicate personal rather than business spending. Transaction data determined to be non-travel and entertainment and in a risk category may indicate personal spend. In response, personal spend service 121 may transmit to transaction approval layer 130 the failure state. In some embodiments, this failure state may be considered critical. If personal spend service 121 determines the transaction is not risky based on the comparison, the transaction data is then compared to similar transaction data by the transaction card holder and/or colleagues. For example, an employee may order a bulk order of promotional t-shirts with the branding of the organization. Personal spend service 121 may determine the transaction is not travel and entertainment. However, clothing may not be considered a risky category. Metadata associated with the transaction may indicate the merchant details. Personal spend service 121 can compare this data with stored data in customer data database 132 and transaction data database 134. This information may indicate the transaction card holder has previously purchased the same or similar order from the same merchant. This may indicate a history of approved transactions and personal spend service 121 may transmit information to transaction approval layer 130 indicating the business travel thresholds are satisfied and there is no failure state.

In some embodiments, anomaly detection service 122 determines whether the transaction is anomalous to the transaction card and/or transaction history associated with the organization. In some embodiments, anomaly detection service 122 may compare travel and entertainment transaction data to previous transaction data of the transaction card holder and/or organization to detect anomalies. Anomalies may include abnormal spend amounts, merchant anomaly, wasteful spending, late night hours, location anomalies, home/weekend spending, and/or similar transaction data that may indicate the transaction is not business related. Anomaly detection service 122 may analyze the transaction for each of the anomaly categories. If an anomaly is detected, anomaly detection service 122 may transmit the failure state to transaction approval layer 130. In some embodiments, anomalies may be detected in several categories. Anomaly detection service 122 may transmit each of the anomalies to transaction approval layer 130. Transaction approval layer 130 may use to the number of anomalies to determine if a transaction should be considered healthy, moderate, or critical.

For example, a transaction may include transaction data for a $75 spend at a fast food restaurant in Austin. Similar transactions by colleagues within the organization may indicate a $10 average spend at the same fast food restaurant in Austin. In response, anomaly detection service 122 may determine the transaction data exceeds the spend threshold and is considered an abnormal spend. Merchant anomalies may include transactions with unknown and/or previously unused merchants. Anomaly detection service 122 may compare transaction data with previous transaction data of colleagues to determine that a merchant is previously unused and therefore considered an anomaly. In some embodiments, transaction card holders may receive per diem limits, e.g., daily spending limits, for travel and entertainment. Anomaly detection service 122 may detect wasteful spending if the transaction data is within the per diem limits but significantly more expensive than transaction data of colleagues. For example, several colleagues are on business travel with a per diem of $50. Two of the colleagues may have transactions with transaction data totaling a ˜$20 spend. Another colleague may submit a transaction with transaction data totaling a $49 spend. While within the daily limit, anomaly detection service 122 may determine there is a wasteful spending anomaly and transmit the failure state to transaction approval layer 130.

As described above, anomaly detection service 122 may analyze the transaction to determine if there are late night spend, location, and/or home/weekend spending anomalies. In some embodiments, late night spend combines transaction data and location information to detect the anomaly. For example, consistently ordering a late night meal with the transaction card in the transaction card holder's home city may be a late night spend anomaly. Another example may be consistent late night transportation fares. In some embodiments, anomaly detection service 122 may detect location anomalies using available transaction data, metadata, and/or business trip information from the organization. Location anomalies may include transaction data indicating a transaction in a location other than the location of the business trip. For example, transaction data from a purchase in London when the trip was in Edinburgh. Another example may be a different travel route from a first location to a second location from colleagues with the same first and second location. Additionally, transaction data in known tourist and/or leisure destinations may indicate a failure state to anomaly detection service 122. In some embodiments, anomaly detection service 122 may analyze transaction data to determine if there is a home/weekend spend anomaly. Anomaly detection service 122 may review the transaction card holder data and transaction approval history stored in customer and transaction data databases 132 and 134, respectively. If anomaly detection service 122 determines frequent previous transaction data during the weekend and at home, there may be a failure state. For example, every weekend for a month there transaction card holder spend $20 on a local restaurant. After several attempts, anomaly detection service 122 may transmit the failure state and category to transaction approval layer 130.

As described throughout, each service 121-126 and threshold and/or failure state can be modified to apply the policy of the organization. For example, organizations may offer a benefit of providing rides and/or meals to employees who work late in their office. Therefore, according to the policy of the organization, the late night spending category of anomaly detection service 122 may not be applied or transaction data. In some embodiments, the threshold may be modified to exceedingly late night hours e.g., 12:00 AM-4:00 AM, and/or a location restriction to 2 miles within the office. Customizing transaction management system 110 with such detail provides an improvement over existing technology and systems because transaction management system 110 can provide accurate transaction approvals and denials without manual oversight in many scenarios.

As described above, policy non-compliance service 123 may determine whether the transaction complies with the policy of the organization in certain areas. Policy non-compliance service 123 may compare transaction data with policy requirements such as an advanced booking mandate, preferred merchants, class of service, and/or spend thresholds. For example, the organization's policy may apply a different advanced booking requirement for domestic and international flights. Policy non-compliance service 123 may analyze transaction data that falls within spending thresholds, but exceeds upgrades, standard/class of service, preferential accommodations, and/or rate caps. For example, policy non-compliance service 123 may apply a policy with a maximum spend threshold for flights of a within a certain distance and a restriction to business class or lower. Transaction data may indicate the transaction card holder purchased a first class ticket below the spending threshold. Policy non-compliance service 123 may determine that first class ticket exceed the class restriction of the policy and indicate a failure state to transaction approval layer 130. In some embodiments, the policy may identify preferred hotel supplier. Policy non-compliance service 123 may determine whether the transaction data and/or metadata identifies a merchant categorized as a preferred supplier for hotels in the organization's policy. If the transaction data and/or metadata does not identify a merchant who is a preferred supplier, policy non-compliance service 123 may determine whether a preferred supplier was available. If a preferred supplier was available policy non-compliance service 123 may transmit a failure state to transaction approval layer 130.

In some embodiments, pattern recognition service 124 analyzes transaction data and metadata to determine if there is a pattern of merchant-transaction card holder collusion, repetitive refunding, subscriptions, and/or factoring. In some embodiments, pattern recognition service 124 may detect merchant collusion by analyzing individual and previous transaction data for a transaction card holder and merchant. Individual transactions may be within the spend limits, but repeated and frequent transactions may result in an abnormal gross spending amount. In response, pattern recognition service 124 may transmit the failure state to transaction approval layer 130. In some embodiments, pattern recognition service 124 may detect repetitive refunding on one or more transactions in a transaction. This pattern may indicate the transaction card holder is attempting to monetarily gain from the pattern of purchases and refunds. Pattern recognition service 124 may analyze transaction data and metadata for subscriptions. For example, a reimbursement policy may allow transaction card holder to make purchases from online delivery services. However, the policy may not allow reimbursement for subscription fees to these services. Pattern recognition service 124 may determine if transaction data from a subscription service is for the goods purchased or the subscription to the service. If the transaction data indicated purchase of the service, pattern recognition service 124 may transmit a failure state to transaction approval layer 130. In some embodiments, pattern recognition service 124 detects factoring. Factoring may include transactions between a transaction card holder and affiliated merchant such that the transaction card holder may have monetary gain from the transaction. Customer data database 132 may store demographic information of transaction card holders and identify affiliations between transaction card holders and merchants. If an affiliation exists, pattern recognition service 124 may transmit a failure state to transaction approval layer 130.

In some embodiments, payment risk service 125 may analyze transaction data to predict the next stage of delinquency for a transaction card holder. Pattern recognition service 124 may assess spend behavior, previous delinquency, bureau information, remit information, transaction card holder information, and policies of the organization to predict future delinquency. In some embodiments, transaction management system 110 provides automated reimbursement for all approved, healthy transactions. However, for some moderate and/or critical transactions, transaction management system 110 may need final approval from client decision system 150 before reimbursing the transaction card. Additionally, for transactions that are not approved, the transaction card holder may be responsible for paying the balance. Payment risk service 125 may determine that the transaction card holder is delinquent or at risk of being delinquent and transmit a failure state to transaction approval layer 130 to prevent and/or discourage future transactions.

In some embodiments, questionable spend service 126 may analyze transaction data in categories that are considered illegitimate and/or prohibited for the transaction card. Questionable spend service 126 may assign a risk weight to different categories so that the most “risky” e.g., least likely to be a reimbursable transaction, is given the highest weight. For example, non-travel and entertainment categories may be considered risk categories. Risk categories may include dating/escort/massage services, jewelry, suspicious merchants, leisure, high risk-transportation, digital wallet, cosmetic goods and services, funeral services, charity, liquor stores, clubs, apparel, ecommerce, and/or department stores. Questionable spend service 126 may assign the highest weight to categories dating, jewelry, suspicious merchants, and/or similar categories considered high risk. Categories similar to apparel, ecommerce, and/or department stores may receive the lowest weight. These categories may have some risk, but could reasonably be reimbursable transactions. In some embodiments, the policy of the organization may further modify the risk categories and assigned weights. For example, an organization that specializes in advertisement and marketing might not consider apparel and ecommerce transactions to be risky at all, because they are common within the organization. In some embodiments, the risk categories may be further divided into subcategories with individual risk weights.

Questionable spend service 126 analyzes transactions to generate a transaction score. The transaction score is a sum of the individual risk weights for the transaction. In some embodiments, the transaction score may take into account the risk weight, timing, frequency, and monetary value of the transaction. Questionable spend service 126 may apply a threshold to the transaction score so that transactions exceeding the threshold result in a failure state. Additionally, questionable spend service 126 may develop a transaction account score, which includes the history of the transaction card holder's previous transaction scores. Questionable spend service 126 may apply a threshold to the transaction account score as well. In some embodiments, if either the transaction score or transaction account score exceeds the threshold, questionable spend service 126 may transmit a failure state to transaction approval layer 130.

As described throughout, customer metadata database 132 and transaction data database 134 store data used by transaction management system 110 to analyze transaction data. Customer metadata database 132 may store demographic information of transaction card holders, previous travel history, and/or data received from client decision system 150. Transaction data database 134 may store current and previous transaction data. Databases 132 and 134 may store data locally and/or portions stored remotely and accessible by transaction management system 110.

In some embodiments, transaction approval layer 130 may receive the failure state information from services 121-126 to determine whether the transaction should be classified as healthy, moderate, or critical. Transaction approval layer 130 may receive failure state information from services 121-126 for each transaction that is purchased and/or occurring within a relevant time frame, e.g., flights and hotel may be booked a week a part but for overlapping dates such that they may be especially relevant to each other in classifying the transactions. In some embodiments, each service 121-126 may transmit a numerical score to transaction approval layer 130 indicating whether there was a failure state. In some embodiments, each service may be equally weighted and with a binary score of 0 or 1, where 0 is representative of a failure state. Transaction approval layer 130 may produce a cumulative score for the transaction. In some embodiments, the organizational policy may instruct transaction approval layer 130 on how to determine healthy, moderate, or critical transactions based on the transaction score. For example, a healthy transaction may occur when each service 121-126 transmits failure state information indicating the transaction satisfied each threshold of services 121-126. In some embodiments, the policy may allow for one failure state or failure states from only certain services. For example, the policy may indicate that a transaction causing a failure state in personal spend service 121 may still be considered healthy, but a transaction causing a failure state from policy non-compliance service 123 may be considered moderate or critical. In some embodiments the number of failure states and/or corresponding service may distinguish between moderate and critical transactions. For example, a transaction causing two failure states from services 121-126 may be classified as moderate and more than two failure states may be classified as critical. Moderate transactions may require final approval from client decision system 150 before approval and reimbursement. Critical transactions may be categorically denied.

In some embodiments, transaction approval layer 130 may also determine a transaction account score. The transaction account score may be a cumulative score of the transaction card holder's previous transaction classifications. Transaction approval layer 130 may use this score in conjunction with the transaction score to determine healthy, moderate, or critical transactions. For example, if the transaction score indicates a healthy transaction but the transaction card holder has a history of moderate or critical transactions, transaction approval layer 130 may determine the current transaction is moderate or critical. The frequency and time since moderate or critical transactions may determine the weight given to those transactions in the transaction account score. For example, if a transaction card holder had 3 moderate and 2 critical transactions more than 5 years ago and a recent history of 8 healthy transactions, the moderate and critical transactions may hold less weight in the transaction account score. In some embodiments, previous transactions similar to the current transactions may hold a greater weight. Transaction approval layer 130 may combine various weighting algorithms or implement an algorithm according to the organizational policy.

Transactions classified as healthy may be approved and reimbursed. Transaction management system 110 may request a transfer of funds from a financial account of the organization to reimburse the transaction card. When transaction approval layer 130 classifies the transaction, transaction management system 110 may transmit a message to client decision system 150. The message may indicate whether the transaction was classified as healthy, moderate, or critical and whether additional approval is needed. If the transaction was healthy, the message may also indicate the reimbursement status. In some embodiments, the message may contain detailed information regarding the transaction score, transaction account score, and/or failure state information for each service 121-126. The message may contain graphical user interface (GUI) data. This may allow the information to be readily displayed on client decision system 150. For moderate transactions, this may allow client decision system 150 to easily access and view the information to provide final approval or denial. In some embodiments, this information may also be used to further review the organization's policy and further customize transaction management system 110 to more accurately handle approvals and denials of transactions.

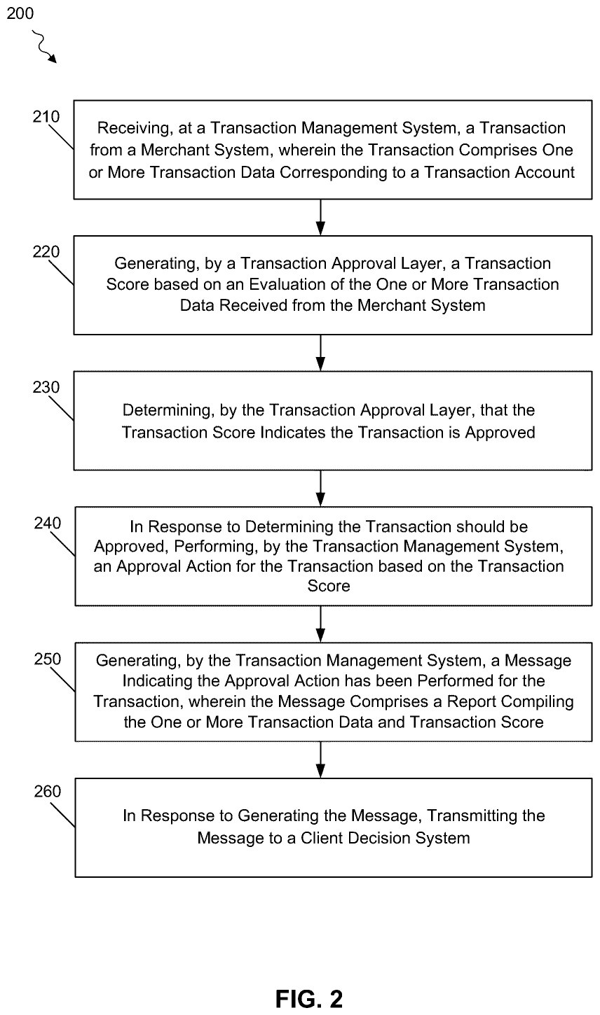

FIG. 2 depicts a flowchart illustrating a method for approving and reimbursing transactions by a transaction management system, according to some embodiments. Method 200 shall be described with reference to FIG. 1; however, method 200 is not limited to that example embodiment.

In an embodiment, transaction management system 110 may utilize method 200 to apply a transaction reimbursement policy to transactions from transaction cards. The transactions may comprise transaction data occurring within a recent time period, e.g., days or weeks. The transactions may represent business transactions qualifying for reimbursement under the transaction reimbursement policy. The foregoing description will describe an embodiment of the execution of method 200 with respect to transaction management system 110. While method 200 is described with reference to transaction management system 110, method 200 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2, as will be understood by a person of ordinary skill in the art.

At 210, transaction management system 110 receives a transaction comprising transaction data corresponding to a transaction account. Transaction management system 110 may receive transaction data directly from one or more merchant systems 140. Merchant systems 140 may include point-of-sale devices, virtual and/or physical. For example, a transaction card holder may purchase flights and book hotel rooms for business travel using the transaction card. Transaction management system 110 may automatically receive the transaction data from merchant systems 140 at some point after the transaction occurs but without any additional user action such as submitting an approval request. In some embodiments, transaction management system 110 is operated by the issuing financial institution of the transaction card and may receive all transaction data for the transaction card at the time of or shortly after the transaction. Transaction data and metadata corresponding to the transaction may be stored in transaction data database 132 and customer metadata database 132, respectively. In some embodiments, the transaction account may be associated with a transaction card and transaction card holder, which may have corresponding previous transaction data and metadata stored in databases 132 and 134.

At 220, transaction management system 110 generates a transaction score based on an evaluation of the transaction data received from the merchant systems 140. In some embodiments, as previously described, transaction approval layer 130 may generate the transaction score. In some embodiments, the transaction score is based on the threshold and failure state information from transaction data evaluation engine 120. Transaction data evaluation engine 120 identifies a plurality of applicable thresholds to evaluate the transaction data against to determine one or more failure states for each of the thresholds. As described with reference to FIG. 1, transaction data evaluation engine 120 may determine whether each or a subset of services 121-126 will be used to analyze transaction data and metadata for the transaction. In some embodiments, the one or more transactions may have a different set or subset of applicable services 121-126. For example, questionable spend service 126 is applicable to non-travel and entertainment transactions, therefore transaction data evaluation engine 120 may not identify questionable spend service 126 to analyze the transaction data and metadata related to transportation and lodging.

In some embodiments, services 121-126 transmit the threshold and failure state information to transaction approval layer 130. Transaction approval layer 130 generates a transaction score based on the threshold and failure state information. Each organizational may utilize transaction approval layer 130 differently to generate a transaction score. For example, each service 121-126 may be weighted equally in the transaction score and having a failure state for one service 121-126 may lower the transaction score such that the transaction is not approved. In some embodiments, some services 121-126 may be weighted more than others so that failing a low weighted threshold for services 121-126 does not prevent the transaction score from being lowered to the point the transaction is not automatically approved. For example, service 125 may not be as much of a concern for an organization so that is given a low weight. Failing the threshold for service 125 may not cause the transaction score to be lowered so that the transaction is not approved, but failing service 125 and another service 121-124 or 126 may. As transaction management system 110 continues to evaluate transaction, the transaction score generation can continue to improve and appropriately modify the weights of service 121-126 in the transaction score.

In some embodiments, each service 121-126 identified as applicable by transaction data evaluation engine 120 at 220 analyze the applicable transaction data and/or metadata of the transaction. For example, there may be transaction by a transaction card holder for transportation and lodging. Transaction data evaluation engine 120 identifies the applicable services 121-126 for each transaction. Transaction data evaluation engine 120 may transmit the failure states, if any, to transaction approval layer 130 for each transaction. Transaction approval layer 130 may give more weight to the relevant transactions than other previous transactions by the transaction card holder.

At 230, transaction management system 110 determines the transaction score indicates the transaction is approved. In some embodiments, transaction approval layer 130 may determine the transaction is approved based on the transaction score. In some embodiments, when the thresholds are satisfied, there is no failure state. For example, policy non-compliance service 123 may analyze the transaction data and metadata to confirm transaction data related to lodging for business travel complies with the preferred hotel merchant, rate cap, check-in/check-out data, and/or class of hotel. In some embodiments, transaction approval layer 130 may also access a transaction account score from customer data database 132. This score may encompass the transaction account approval history. Transaction approval layer 130 may use a combination of the transaction score and transaction account score to determine the transaction should be approved.

As described above, the transaction score may be a score representing failure state information from services 121-126 based on the current transaction. The transaction account score may represent the previous classification history of transactions by the transaction card holder. In some embodiments, transaction approval layer 130 may give some weight in the transaction to other relevant transactions, e.g., transactions for transportation, lodging, food, and beverages. Transaction approval layer 130 may use the transaction data and/or metadata to determine that the transactions are related, e.g., using time of purchase or occurrence, and give weight to these transaction in the transaction score. For example, flight and lodging transactions may have no failure states, however food and beverage transactions may have failure states that indicate a critical classification. Transaction approval layer 130 may give weight to these transactions in the transaction score because they may not yet be included in the previous transaction history of the card holder for the transaction account score. This may cause each of the relevant transaction to be classified as moderate or critical. In some embodiments, according to policy, each transaction may be classified individually and transaction approval layer 130 may determine the category of healthy, moderate, or critical based on a minimum threshold for each category.

At 240, transaction management system 110 performs and approval action. In some embodiments, transaction approval layer 130 classifies the transactions as healthy, moderate, or critical. The classification may be based on failure state information from transaction data evaluation engine 120. Transaction data evaluation engine 120, based on analysis by applicable services 121-126, may transmit failure states to transaction approval layer 130. When all the thresholds of applicable services 121-126 are satisfied, there are no failure states and transaction data evaluation engine 120 transmits information indicating all thresholds were satisfied. In response, transaction approval layer 130 may classify the transaction as healthy.

In some embodiments, transaction approval layer 130 may also determine a transaction account score. The transaction account score may be a cumulative score of the transaction card holder's previous transaction classifications. Transaction approval layer 130 may use both the transaction score and transaction account score to determine the transaction classification.

At 250, transaction management system 110 generates a message indicating the approval action has been performed for the transaction. In some embodiments, the message comprises a report compiling the transaction data, metadata, threshold/failure state information, and/or classification to display via a graphical user interface (GUI). In some embodiments, the report may indicate the transaction data, threshold the transaction data was measured against, and comparison to previous transaction card holder and/or colleague transactions. For example, for the threshold information regarding anomaly detection service 122, transaction data indicate the amount spent, location, and/or merchant may be displayed and compared to colleague data retrieved from customer data database 132 and/or transaction data database 134. The report may give detailed information regarding how the threshold was satisfied and no failure state existed.

At 260, transaction management system 110 may transmit the message to client decision system 150. In some embodiments, client decision system 150 may include expense auditors for the organization. Client decision system 150 may send a notification to the transaction card holder indicating receipt of the message.

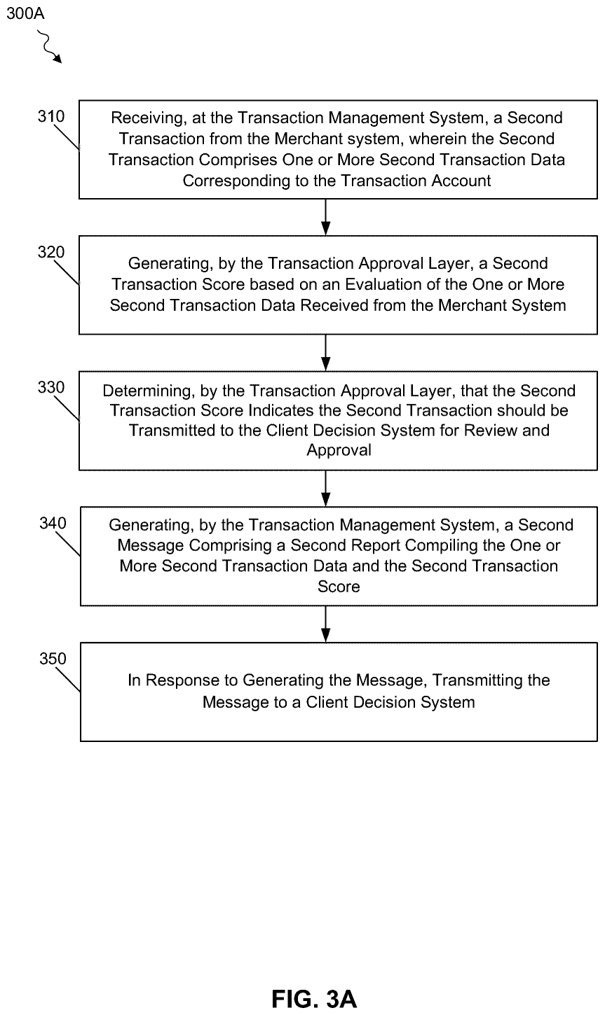

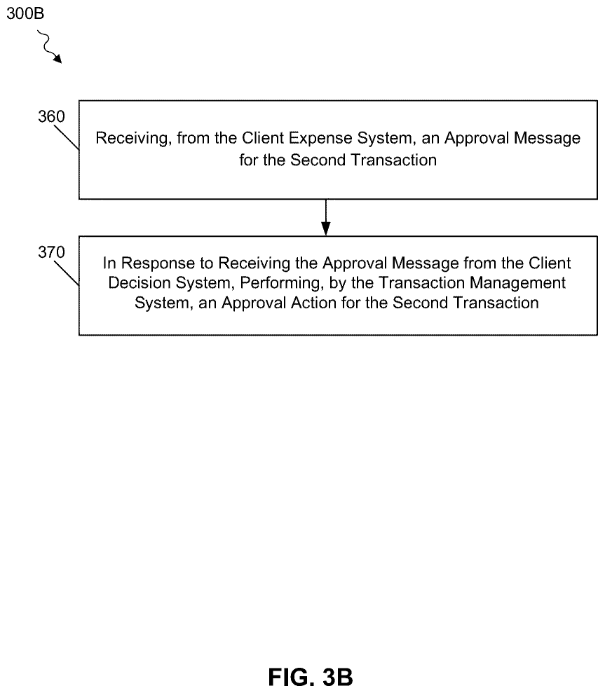

FIG. 3A depicts a flowchart illustrating a method for determining a transaction may not qualify for reimbursement according to a reimbursement policy of an organization, according to some embodiments. Method 300A shall be described with reference to FIGS. 1 and 2; however, method 300A is not limited to that example embodiment.

In an embodiment, transaction management system 110 may utilize method 300A to apply reimbursement policy to transactions from transaction cards. The transactions may qualify for reimbursement under the reimbursement policy of an organization, but initially failing the analysis because the transaction data does not satisfy thresholds for services 121-126. The foregoing description will describe an embodiment of the execution of method 300A with respect to transaction management system 110. While method 300A is described with reference to transaction management system 110, method 300A may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 310, transaction management system 110 receives a second transaction comprising one or more second transaction data corresponding to a transaction card holder. Transaction management system 110 may receive second transaction data from one or more merchant systems 140. Merchant systems 140 may be point-of-sale devices, virtual and/or physical. For example, a transaction card holder may purchase flights and book hotel rooms for business travel using the transaction card. Transaction management system 110 may receive the transaction data from merchant systems 140 when the transaction occurs. In some embodiments, transaction management system 110 is operated by the issuing financial institution of the transaction card and receive all transaction data for the transaction card as it occurs. Transaction data and metadata corresponding to the transaction may be stored in transaction data database 132 and customer metadata database 132, respectively.

At 320, transaction management system 110 generates a second transaction score based on an evaluation of the one or more second transaction data received from the merchant systems 140. In some embodiments, as previously described, transaction approval layer 130 may generate the transaction score. In some embodiments, the transaction score is based on the threshold and failure state information from transaction data evaluation engine 120. Transaction data evaluation engine 120 identifies a plurality of applicable thresholds to evaluate the transaction data against to determine one or more failure states for each of the thresholds. As described with reference to FIG. 1, transaction data evaluation engine 120 may determine whether each or a subset of services 121-126 will be used to analyze transaction data and metadata for the transaction. In some embodiments, the one or more transactions may have a different set or subset of applicable services 121-126. For example, questionable spend service 126 is applicable to non-travel and entertainment transactions, therefore transaction data evaluation engine 120 may not identify questionable spend service 126 to analyze the transaction data and metadata related to transportation and lodging.

At 330, transaction management service 110 determines the second transaction score indicates the second transaction should be transmitted to client decision system 150 for review and approval. In some embodiments, transaction approval layer 130 may determine the transaction score may not indicate a denial but instead that the transaction needs approval from client decision system 150 before the transaction is approved. A transaction that needs further review and approval may be a transaction that falls below the transaction score approval threshold because a few failure states exist. For example, policy non-compliance service 123 may analyze the transaction data and metadata to determine if the transaction data related to lodging for business travel complies with the preferred hotel merchant, rate cap, check-in/check-out data, and/or class of hotel. In some embodiments, there may be multiple opportunities for the transaction data to create a failure state. Continuing the example, if the transaction data indicates the transaction was for a room at preferred hotel merchant, within the appropriate check-in/check-out dates, and for an accept hotel class, but outside of the rate cap, there may be a failure state. Transaction data evaluation engine 120 may transmit the failure state(s) to transaction approval layer 130 for the transaction data. In some embodiments, the transaction data is analyzed by each service 121-126 regardless of whether a failure state occurs. Failure states may be determined for each service 121-126 and transmitted to transaction approval layer 130.

In some embodiments, when failure states are weighted equally, a few failure states may cause the transaction score generated by transaction approval layer to require the additional review and approval of the transaction data. The weight failure states make up in the transaction score may be determined by organizational policy and the transaction score thresholds for automatic approval, review and approval, and denial may be determined by organizational policy. Additionally, in some embodiments, the transaction score alone may be too low to be classified as healthy (e.g., automatic approval) or moderate (e.g., review and approval or denial), but the transaction account score may raise the combined score such that transaction approval layer 130 can determine the transaction should be classified as healthy or moderate.

At 340, transaction management system 110 generates a message comprising a second report compiling one or more second transaction data and the second transaction score. In some embodiments, the message comprises a report compiling the second transaction score, transaction data, metadata, and threshold/failure state information to display via a graphical user interface (GUI). In some embodiments, the report may indicate the transaction data, threshold it was measured against, and comparison. The report may indicate detailed information regarding which threshold was not satisfied, causing a failure state. Continuing the example at 330, the report may compile the compared transaction data and metadata compared with the policy non-compliance service 123 thresholds. The report may include that the transaction data indicates the transaction was for a room at preferred hotel merchant, within the appropriate check-in/check-out dates, and for an accept hotel class, but outside of the rate cap, causing the failure state. The report may specify the exact monetary values to show how the threshold was exceeds or otherwise not met.

In some embodiments, the report may also indicate whether the transaction was classified as moderate or critical by transaction approval layer 130. This may provide additional indication to client decision system 150 on the severity of the failure state, e.g., a single or few failures states compared to a several failure states. As described above, in some embodiments moderate transactions may be approved via instruction received from client decision system 150 after transmitting the message at 350.

At 350, transaction management system 110 may transmit the message to client decision system 150. In some embodiments, client decision system 150 may include expense auditors for the organization. Client decision system 150 may send a notification to the transaction card holder indicating receipt of the message.

FIG. 3B depicts a flowchart illustrating a method for receiving instructions to classify a transaction as healthy even though failure state(s) exist, according to some embodiments. Method 300B shall be described with reference to FIGS. 1, 2, and 3A; however, method 300B is not limited to that example embodiment.

In an embodiment, transaction management system 110 may utilize method 300B to perform an approval action for a transaction that was previously classified as moderate or critical and therefore not approved. The foregoing description will describe an embodiment of the execution of method 300B with respect to transaction management system 110. While method 300B is described with reference to transaction management system 110, method 300B may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 360, transaction management system 110 may receive an approval message for the second transaction from client decision system 150. In some embodiments, the instruction may be in response to a message transmitted from transaction management system 110 to client decision system 150 indicating the transaction was classified as moderate or critical and therefore not approved. As described above, a moderate transaction may have a failure state that exceeds the strict threshold limits for transaction data analyzed by transaction data evaluation engine 120. However, there may be circumstances that would indicate the transaction should be labeled as healthy and approved. To classify the transaction as healthy and/or approve the transaction, review and instruction from client decision system 150 may be required.

For example, if policy non-compliance service 123 determines that, based on the transaction data, all of the thresholds are met for a hotel reservation except the value of the transaction exceeds the rate cap, this would cause a failure state, e.g., failure state determined at 330 of FIG. 3A. However, client decision system 150 may review the report transmitted in the message from transaction management system 110 and determine the exceed rate cap is acceptable and the transaction should be approved regardless of the failure state.

In some embodiments, transaction management system 110 may update or re-train the machine learning models user for subjective decisioning with the approval data for a transaction previously classified as moderate. Updating and/or retraining the machine learning models may allow transaction management system 110 to improve subjective decisioning in classifying transactions. Over time transaction management system 110 may classify fewer transactions as moderate, because of the updating and re-training of the machine learning models with additional data.

At 370, in response to receiving the instruction from client decision system 150, transaction management system 110 performs and approval action. The approval action may cause transaction management system 110 to instruct the issuing financial institution to transfer funds at the amount of the transaction from a financial account of the organization to cover the funds of the one or more transactions on the transaction card.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 518 may be a floppy disk, magnetic tape, compact disk, DVD, optical storage disk, /d/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 500 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving, at a transaction management system, a transaction from a merchant system, wherein the transaction comprises transaction data corresponding to a transaction account;
generating, by a transaction approval layer, a transaction score based on an evaluation of the transaction data received from the merchant system;
determining, by the transaction approval layer, that the transaction score indicates the transaction is approved;
in response to determining the transaction should be approved, performing, by the transaction management system, an approval action for the transaction based on the transaction score;
generating, by the transaction management system, a message indicating the approval action has been performed for the transaction, wherein the message comprises a report compiling the transaction data and the transaction score; and
in response to generating the message, transmitting the message to a client decision system.

2. The computer implemented method of claim 1, further comprising:
receiving, at the transaction management system, a second transaction from the merchant system, wherein the second transaction comprises one or more second transaction data corresponding to the transaction account;
generating, by the transaction approval layer, a second transaction score based on an evaluation of the one or more second transaction data received from the merchant system;
determining, by the transaction approval layer, that the second transaction score indicates the second transaction should be transmitted to the client decision system for review and approval;
in response to determining the second transaction should be transmitted to the client decision system, generating, by the transaction management system, a second message comprising a second report compiling the one or more second transaction data and the second transaction score;
in response to generating the message, transmitting the message to the client decision system;
receiving from the client decision system, an approval message for the second transaction; and
in response to receiving the approval message from the client management system, performing, by the transaction management system, an approval action for the second transaction.

3. The computer implemented method of claim 1, further comprising:
receiving, at the transaction management system, a second transaction from the merchant system, wherein the second transaction comprises one or more second transaction data corresponding to the transaction account;
generating, by the transaction approval layer, a second transaction score based on an evaluation of the second transaction data received from the merchant system;
determining, by the transaction approval layer, that the second transaction score indicates the second transaction should not be approved;
in response to determining the second transaction should not be approved, generating, by the transaction management system, the message indicating the second transaction has been not been approved, wherein the message comprises the report compiling the transaction data or transaction score; and
in response to generating the message, transmitting the message to a client decision system.

4. The computer implemented method of claim 1, wherein generating the transaction score further comprises:
identifying, by a transaction data evaluation engine, a plurality of thresholds;
associated with the transaction, wherein a transaction data evaluation engine is configured to evaluate at least one of the transaction data based on the identified plurality of thresholds;
evaluating, by the transaction data evaluation engine, the transaction data against the plurality of thresholds; and
determining, by the transaction data evaluation engine, the transaction data satisfies the plurality of thresholds, wherein the transaction approval layer generates the transaction score based on the determining by the transaction data evaluation engine that the transaction data satisfies the plurality of thresholds.

5. The computer implemented method of claim 4, wherein one of the plurality of thresholds is an anomaly detection threshold that determines whether the transaction data corresponds to anomalies for at least one of: a location of the transaction, an amount of the transaction, or a type of merchant.

6. The computer implemented method of claim 4, wherein one of the plurality of thresholds is a questionable spend threshold that determines whether the transaction data is associated with a risky merchant based on a weight assigned to the transaction data, wherein the transaction data is assigned a weight based on a risk weight of a merchant and merchants considered to be risky are assigned a higher risk weight.

7. The computer implemented method of claim 4, wherein one of the plurality of thresholds is a payment risk threshold that analyzes one or more previous payments for the transaction account to determine whether a transaction account holder will pay an amount of the transaction.

8. A system, comprising:
a memory; and
at least one processor coupled to the memory and configured to:
receive, at a transaction management system, a transaction from a merchant system, wherein the transaction comprises transaction data corresponding to a transaction account;
generate, by a transaction approval layer, a transaction score based on an evaluation of the transaction data received from the merchant system;
determine, by the transaction approval layer, that the transaction score indicates the transaction should be approved;
in response to determining the transaction should be approved, performing, by the transaction management system, an approval action for the transaction based on the transaction score;
generate, by the transaction management system, a message indicating the approval action has been performed for the transaction, wherein the message comprises a report compiling the transaction data and transaction score; and
in response to generating the message, transmitting the message to a client decision system.

9. The system of claim 8, wherein the at least one processor is further configured to:
receive, at the transaction management system, a second transaction from the merchant system, wherein the second transaction comprises one or more second transaction data corresponding to the transaction account;
generate, by the transaction approval layer, a second transaction score based on an evaluation of the one or more second transaction data received from the merchant system;
determine, by the transaction approval layer, that the second transaction score indicates the second transaction should be approved by the client decision system;
in response to determining the second transaction should be approved by the client decision system, generating, by the transaction management system a second message comprising a second report compiling the one or more second transaction data and the second transaction score;
in response to generating the message, transmitting the message to the client decision system;
receive from the client decision system, an approval message for the second transaction; and
in response to receiving the approval message from the client decision system, performing, by the transaction management system, an approval action for the second transaction.

10. The system of claim 9, wherein the at least one processor is further configured to:
receive, at the transaction management system, a second transaction from the merchant system, wherein the second transaction comprises one or more second transaction data corresponding to the transaction account;
generate, by the transaction approval layer, a second transaction score based on an evaluation of the second transaction data received from the merchant system;
determine, by the transaction approval layer, that the second transaction score indicates the second transaction should not be approved;
in response to determining the second transaction should not be approved, generating, by the transaction management system, the message indicating the second transaction has been not been approved, wherein the message comprises the report compiling the transaction data or transaction score; and
in response to generating the message, transmitting the message to a client decision system.

11. The system of claim 9, wherein to generate the transaction score the at least one processor is further configured to:
identify, by a transaction data evaluation engine, a plurality of threshold
associated with the transaction, wherein a transaction data evaluation engine is configured to evaluate at least one of the transaction data based on the identified plurality of thresholds;
evaluate, by the transaction data evaluation engine, the transaction data against the plurality of thresholds; and
determine, by the transaction data evaluation engine, the transaction data satisfies the plurality of thresholds, wherein the transaction approval layer generates the transaction score based on the determining by the transaction data evaluation engine that the transaction data satisfies the plurality of thresholds.

12. The system of claim 11, wherein one of the plurality of thresholds is an anomaly detection threshold that determines whether the transaction data corresponds to anomalies for at least one of: a location of the transaction, an amount of the transaction, or a type of merchant.

13. The system of claim 11, wherein one of the plurality of thresholds is a questionable spend threshold that determines whether the transaction data is associated with a risky merchant based on a weight assigned to the transaction data, wherein the transaction data is assigned a weight based on a risk weight of a merchant and merchants considered to be risky are assigned a higher risk weight

14. The system of claim 11, wherein one of the plurality of thresholds is a payment risk threshold that analyzes one or more previous payments for the transaction account to determine whether a transaction account holder will pay an amount of the transaction.

15. A non-transitory computer-readable device having instructions stored thereon that, when executed by at least one computing device, cause the at least one computing device to perform operations comprising:
receiving, at a transaction management system, a transaction from a merchant system, wherein the transaction comprises transaction data corresponding to a transaction account;
generating, by a transaction approval layer, a transaction score based on an evaluation of the transaction data received from the merchant system;
determining, by the transaction approval layer, that the transaction score indicates the transaction should be approved;
in response to determining the transaction should be approved, performing, by the transaction management system, an approval action for the transaction based on the transaction score;
generating, by the transaction management system, a message indicating the approval action has been performed for the transaction, wherein the message comprises a report compiling the transaction data and transaction score; and
in response to generating the message, transmitting the message to a client decision system.

16. The non-transitory computer-readable device of claim 15, the operations further comprising:
receiving, at the transaction management system, a second transaction from the merchant system, wherein the second transaction comprises one or more second transaction data corresponding to the transaction account;
generating, by the transaction approval layer, a second transaction score based on an evaluation of the one or more second transaction data received from the merchant system;
determining, by the transaction approval layer, that the second transaction score indicates the second transaction should be approved by the client decision system;
in response to determining the second transaction should be approved by the client decision system, generating, by the transaction management system a second message comprising a second report compiling the one or more second transaction data and the second transaction score;
in response to generating the message, transmitting the message to a client decision system;
receiving from the client decision system, an approval message for the second transaction; and
in response to receiving the approval message from the client management system, performing, by the transaction management system, an approval action for the second transaction.

17. The non-transitory computer-readable device of claim 15, the operations further comprising:
receiving, at the transaction management system, a second transaction from the merchant system, wherein the second transaction comprises one or more second transaction data corresponding to the transaction account;
generating, by the transaction approval layer, a second transaction score based on an evaluation of the second transaction data received from the merchant system;
determining, by the transaction approval layer, that the second transaction score indicates the second transaction should not be approved;
in response to determining the second transaction should not be approved, generating, by the transaction management system, the message indicating the second transaction has been not been approved, wherein the message comprises the report compiling the transaction data or transaction score; and
in response to generating the message, transmitting the message to a client decision system.

18. The non-transitory computer-readable device of claim 16, wherein to generate the transaction score the operations further comprising:
identifying, by a transaction data evaluation engine, a plurality of threshold associated with the transaction, wherein a transaction data evaluation engine is configured to evaluate at least one of the transaction data or metadata based on the identified plurality of thresholds;
evaluating, by the transaction data evaluation engine, the transaction data against the plurality of thresholds; and
determining, by the transaction data evaluation engine, the transaction data satisfies the plurality of thresholds, wherein the transaction approval layer generates the transaction score based on the determining by the transaction data evaluation engine that the transaction data satisfies the plurality of thresholds.

19. The non-transitory computer-readable device of claim 18, wherein one of the plurality of thresholds is an anomaly detection threshold that determines whether the transaction data corresponds to anomalies for at least one of: a location of the transaction, an amount of the transaction, or a type of merchant.

20. The non-transitory computer-readable device of claim 18, wherein one of the plurality of thresholds is a payment risk threshold that analyzes one or more previous payments for the transaction account to determine whether a transaction account holder will pay an amount of the transaction.
